(19) United States
(12) Patent Application Publication
(10) Pub. No.: US 2011/0158115 A1
(43) Pub. Date: Jun. 30, 2011

(54) Power Efficiency and Packet Delivery Ratio Through Micro Rate Control at Access Point Functionality Enabled Devices

(75) Inventors: Yanjun Sun, Richardson, TX (US); David Levy, Villach (AT); Ofer Guetta, Ganei-Tikva (IL)

(73) Assignee: TEXAS INSTRUMENTS INC., Dallas, TX (US)

(21) Appl. No.: 12/752,434

(22) Filed: Apr. 1, 2010

Related U.S. Application Data
(60) Provisional application No. 61/165,673, filed on Apr. 1, 2009.

(51) Int. Cl. H04L 12/26

(52) U.S. Cl. 370/252

(57) ABSTRACT

Embodiments of the invention provide a method to allow a software access point (SAP)-enabled device to go to sleep as much as possible without sacrificing throughput and latency across networks. The SAP-enabled device defers transmissions from client stations if maximum end-to-end throughput that can be supported by the networks is below the maximum throughput supported by a connection to the client station.

### CROSS-REFERENCE TO RELATED APPLICATIONS

The present application claims the benefit of the filing date of U.S. Provisional Patent Application No. 61/165,673, which is titled “Power Efficiency and Packet Delivery Ratio through Micro Rate Control at Soft AP Enabled Mobile Devices” and was filed Apr. 1, 2009, the disclosure of which is hereby incorporated by reference herein in its entirety.

### TECHNICAL FIELD

Embodiments of the invention are directed, in general, to controlling data flow at wireless access points (AP) and, more specifically, to allowing the AP device to operate in a sleep mode as much as possible without sacrificing throughput and latency.

### BACKGROUND

Embodiments of the invention are directed, in general, to communication systems and, more specifically, methods of improving power efficiency in electronic devices. Early use of “Wi-Fi” or wireless local area network (WLAN) devices based on the IEEE 802.11 standards was typically limited to Personal Computers (PC) and wireless Access Points (AP). The number of other Wi-Fi-enabled devices, such as Consumer Electronic (CE) devices and mobile handsets, is increasing rapidly. The incorporation of Wi-Fi into CE and handset devices in addition to PCs and Access Points enables new usage models for users. For example, a user may want to use his or her cell phone to share, show, print, and synchronize content by connecting with CE devices or mobile handsets of other users through Wi-Fi technologies, with or without an infrastructure network nearby.

Responding to this need, a Wi-Fi Alliance task group is working on a new standard called Wi-Fi Peer-to-Peer, to allow CE and mobile handsets to connect to each other in an ad hoc and peer-to-peer way. One way to achieve this is to provide the Access Point functionality in software (including firmware) at a device so that the device serves as group master or group owner, behaving just like a typical AP. Although the examples used herein include Access Point functionality implemented in software, the present invention also includes embodiments in which such Access Point micro rate control functionality is alternatively or additionally implemented in hardware or firmware.

With the AP functionality added to CE devices or mobile handsets, other devices may act as a client and set up connections with the mobile AP in the same way as they connection to a conventional AP. Access Point functionality is provided by software in most applications. This scheme is referred to as Soft Access Point (SAP) herein. Wi-Fi client or station functionalities are a subset of SAP.

SAP is often implemented on a CE or mobile handset that is battery powered. Limited battery capacity can be a challenge for CE and mobile SAP devices. The SAP design needs to be very power efficient. A conventional AP, however, typically does not have this concern because it has an unlimited power supply. In conventional AP design, the AP does not turn off its radio or “sleep” even if there is no traffic. Such idle channel monitoring consumes a lot of energy and thus is unsuitable for SAP.

### SUMMARY OF THE INVENTION

Embodiments of the invention provide an efficient scheme called micro rate control that reduces energy consumption and improves the packet delivery ratio at SAP-enabled mobile devices. The goal of the algorithm is to turn on the SAP device radio only for a duration that is long enough to support the maximum end-to-end throughput of the entire system. This is different from a conventional AP, which attempts to provide the maximum throughput supported by the PHY rate of the WLAN itself. The scheme disclosed herein complies with the IEEE 802.11 (Wi-Fi) standards and requires less buffer space in firmware (FW) or the host system for SAP support.

In one embodiment, an access point comprises a wireless receiver for receiving data from a first network and a wireless transmitter for transmitting data to one or more devices on the first network. A processor at the access point is coupled to the receiver and the transmitter. The processor is adapted to process data packets received from the first network and to generate messages to be transmitted to the one or more devices. The processor operates to: identify a minimum throughput rate; determine a receive window duration required to support the minimum throughput rate; send transmit instructions to the one or more devices on the first network, the transmit instructions identifying a period of absence; place the receiver in a sleep mode during at least a portion of the period of absence, the sleep mode preventing the receiver from receiving data from the first network; and place the receiver in an active mode at times outside the period of absence. The transmit instructions from the access point identify a start time and a duration for the period of absence and/or an interval separating a plurality of periods of absence.

The access point further comprises a memory coupled to the processor and a battery providing power to the receiver, interface, and processor. The memory stores access point functionality software. The access point further comprises an interface for transmitting data to a second network. The processor further operates to: identify a first throughput rate for the first network; identify a second throughput rate for the second network; and determine a lowest throughput rate between the first throughput rate and the second throughput rate, wherein the lowest throughput rate is the minimum throughput rate. The interface may be a wireless transmitter adapted to transmit data to the second network.

In another embodiment, an access point identifies a first throughput rate for a first network; determines a minimum transmit duration to support the first throughput rate; instructs a device on the first network to transmit only during repetitive transmission windows, wherein a duration of the repetitive transmission windows selected based on the minimum transmit duration; places a receiver in a sleep mode; places the receiver in an active mode during the repetitive transmission windows; and returns the receiver to the sleep mode following the end of the repetitive transmission windows.

A clear to send to self (CTS2Self) frame or a transmission opportunity (TXOP) frame may be used to instruct the device regarding the transmission window. A notice of absence (NoA) or an opportunistic power-save message may also be used to instruct the device regarding the transmission window. The repetitive transmission windows may begin at fixed intervals or at variable intervals. The durations of the repetitive transmission windows may be variable.

The receiver may be placed in an active mode prior to a start time of a repetitive transmission window. The receiver may be placed in an active mode after an end time of a repetitive transmission window.

In a further embodiment, a first throughput rate for a first network is identified; a second throughput rate for a second network is identified; the first throughput rate to the second throughput rate are compared to determine a minimum throughput rate; a repetitive transmission window size required to support the minimum throughput rate is determined; a device is instructed to transmit only during transmission windows, the transmission windows occurring at intervals; a receiver is placed in a sleep mode during periods outside the transmission windows; the receiver is placed in an active mode during the transmission windows; and the receiver is returned to the sleep mode at the end of the transmission windows.

The first network may be a Wi-Fi network operating according to a IEEE 802.11 protocol, and the second network may be a cellular telephone network. The device may be located on the Wi-Fi network. One or more data packets may be received from the device over the first network during the transmission windows, and then forwarded to the data packets to the second network. The transmission windows may begin at variable intervals and the durations of the transmission windows may be variable.

### BRIEF DESCRIPTION OF THE DRAWINGS

Having thus described the invention in general terms, reference will now be made to the accompanying drawings, wherein:

FIG. 1 illustrates a cell phone sending a stored photograph or document to a printer through Wi-Fi for printing;

FIG. 2 illustrates Access Point (AP) and station functionalities implemented in software;

FIG. 3 illustrates rate differences in different networks that cause a SAP-enabled device to receive more packets than the SAP can handle, which wastes energy and may lead to packet drops;

FIG. 4 illustrates a SAP-enabled device cannot turn off its radio even when there is no traffic because of unpredictable packet arrivals; and

FIG. 5 illustrates a system using a micro rate control algorithm that delays transmissions from STAs to delay packet arrivals and to allow AP to go to sleep in accordance with an embodiment of the invention.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

FIG. 1 illustrates a user connecting a CE device or mobile handset 101 to printer 102 through Wi-Fi technologies. This type of ad hoc Wi-Fi connection allows the user to use his cell phone to share, show, print, and synchronize content, such as photographs or documents, with other users. SAP-based cell phone 101 sends a stored photograph or document directly to printer 102 through an ad hoc Wi-Fi connection for printing without requiring a conventional AP or another infrastructure network nearby.

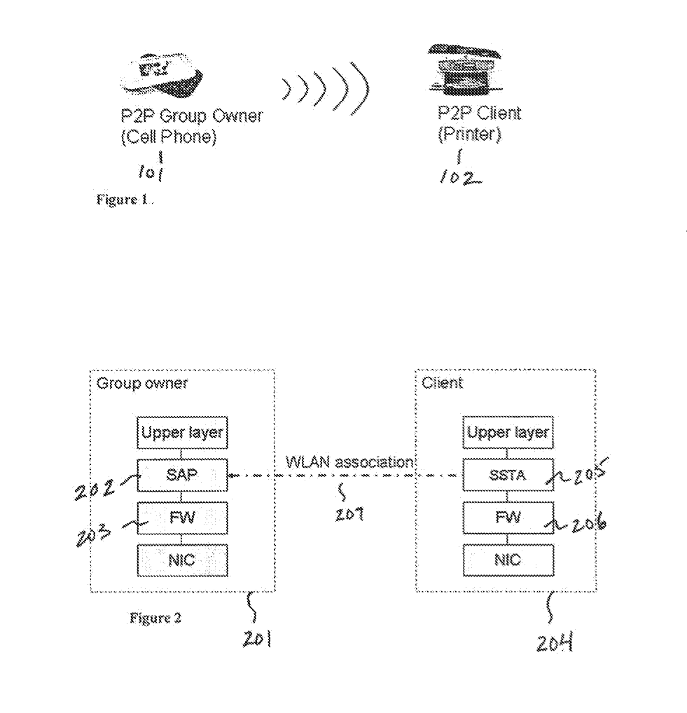

FIG. 2 illustrates Access Point (AP) and station functionalities implemented in software. Device 201, which may be a CE or mobile handset device, for example, includes software-based Access Point (SAP) functionality 202, which may be stored in firmware (FW) 203 or any memory structure in device 201. With the SAP functionality in device 201, another device, such as client device 204, can set up connections with device 201 in the same way that devices connection to a conventional AP. The client can be a conventional station or a device that includes software-based Station functionality (SSTA) 205, which may be stored in firmware 206 or any memory structure in client device 204. Device 201 acts as a group owner to establish an ad hoc WLAN association 207 with client 204.

If devices 201 and 202 are CE or mobile handsets, then the SAP based ad hoc solution illustrated in FIG. 2 must address limited battery capacity of device 201 and 202. One method of minimizing power consumption to operate more efficiently is to turn off the radio on device 201 and/or 204 when there is no traffic on the ad hoc WLAN network. In one embodiment, device 201 may use micro rate control in order to reduce energy consumption and to improve packet delivery ratio. Micro rate control allows device 201 to turn on its radio only long enough to support maximum end-to-end throughput of the ad hoc network.

Two of the most common uses of SAP are bridging to a cellular network and peer-to-peer data exchange. Because SAP typically runs on a mobile device that often has limited capacity in energy, computation and communication, SAP faces more challenges than convention AP.

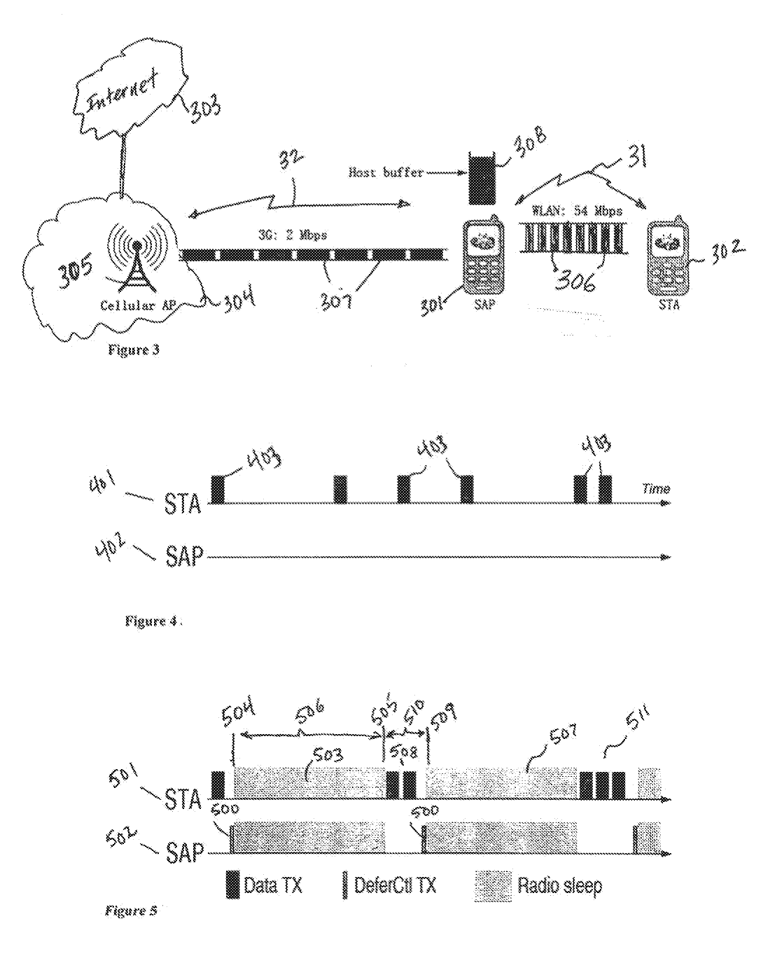

FIG. 3 illustrates an example of bridging to a cellular network. Cell phone 301 serves as a bridge between WLAN 31 and cellular network link 32. Cell phone 301 behaves as an SAP and allows cell phone 302 on the WLAN to access Internet 303 through cellular network 304 and cellular access point 305. Packets 306 are transmitted over the WLAN 31 between cell phones 301 and 302. Packets 307 are transmitted over a cellular network connection 32, such as a 3G cellular link, between cell phone 301 and cellular access point 305. In the illustrated embodiment, packets 306 and 307 are of the same size. Their respective widths in FIG. 3 are used to illustrate transmission delays on the different networks. Packets 306 on the WLAN link 31 are much narrower because they experience a much shorter transmission delay than those along the cellular network link 32. The WLAN link 31 is much faster than the cellular link 32. Although other embodiments of the cellular network could provide faster data transmission rates than the 2 Mbps illustrated in FIG. 3, so could other embodiments of the WLAN provide data rates faster than 54 Mbps. For example, when the IEEE 802.11n protocol is used on the WLAN, the rate difference between a WLAN link 31 and a cellular link 32 will be larger. Because the cellular link is only 2 Mbps, the realistic maximum end-to-end throughput is even lower than that. No matter how much throughput the WLAN link provides 31, the useful portion of the end-to-end connection is less than 2 Mbps. The rate difference between the WLAN network and the cellular network may cause SAP device 301 to receive more packets than it can handle, which wastes energy and may lead to packet drops.

The imbalanced rates on either side of the SAP device 301 may lead to unnecessary processing of incoming packets and/or buffer overflow. Packets 306 can arrive at a much faster rate through the WLAN link than the packets 307 can leave through the cellular network link. This is especially true when there is UDP traffic or when multiple stations (STAs) access the internet through the SAP device 301. The packets that cannot be immediately sent through the 3G network are added to buffer 308 of the SAP device 301. There are two drawbacks with this buffering. First, due to the large rate difference, the SAP device 301 requires more buffer space either in firmware or the host system. Buffering these packets often consumes more energy than simply forwarding them because more processing overhead is involved. Second, buffer overflow is unavoidable due to limited buffer space. As a result, not only does the delivery ratio go down, but also the energy required to transmit and receive the dropped packets is wasted.

In one embodiment of the invention, the WLAN radio cycle between two states: (1) on for a short period of time to support the less than 2 Mbps throughput; and (2) off for a long period of time to save energy. In scheme described herein, the rate of incoming packets via the WLAN link is limited so that the SAP device 301 spends energy only for packets that the SAP device 301 can handle. To save energy, the rate-limiting scheme also puts SAP device 301 into a sleep mode when no packets are expected to arrive.

It will be understood that the present invention is not limited to transferring data packets across combined WLAN 31 and cellular network links 32 as described in the exemplary embodiment of FIG. 3. The connection between device 301 and 302 (e.g. network link 31) and/or between device 301 and 305 (e.g. network link 32) may be any associated with any wireless standard, such as any second generation (2G) cellular network technology and standards (using, for example, CDMA, TDMA, or GSM), third generation (3G) cellular network technology and standards (using, for example, EDGE, UMTS, or CDMA2000), and forth generation (4G) and later cellular network technology and standards (using, for example, LTE/SAE or MIMO). Alternatively, the wireless connections between device 301 and 302 and/or between device 301 and 305 may support any implementations or versions of the Wi-Fi (i.e. IEEE 802.11), WiMAX (i.e. IEEE 802.16), ZigBee, Bluetooth, HomeRF or any other peer-to-peer (P2P) or ad hoc communication protocols or standards.

In other embodiments, either or both link 31 and 32 may be a wireline interface. For example, SAP device 301 may be a battery-powered mobile handset capable of accessing Internet 303 via a wireline or Ethernet connection (not shown) and simultaneously communicating with one or more other devices (302) via a wireless connection.

The standard or protocol supporting links 31 and 32 may be the same or different on each link. Embodiments of the present invention control the flow of data across one or both links to ensure that packets received over a link with a fast throughput or data transmission rate do not overload the SAP device with packets that cannot be promptly transmitted over a link with a relatively slower throughput or data transmission rate.

It will be understood that devices 301 and 302 are not limited to cellular telephone devices. In alternative embodiments, devices 301 and 302 may be any mobile handset, “smart phone,” personal digital assistant (PDA), personal computer (PC), notebook computer, wireless network device (e.g., a personal computer having a wireless local area network (WLAN) network interface), press-to-talk personal communication services (PCS) device, iPhone, iPad, hand-held game system, electronic book, stereo component, television, or other wireless or Internet-enabled consumer electronics (CE) device.

FIG. 4 illustrates an example of a peer-to-peer data exchange use-case. For simplicity, only data transmission from the client (STA 401) to the SAP-enabled device (402) is shown. The inter-arrival time of data packets 403 is often random, resulting in bursty traffic. The SAP device 402 has to stay active fulltime in a receiving or listening mode because the packet 403 arrival times are unpredictable. Therefore, the SAP 402 spends excess energy powering its transceiver while in a waiting state without receiving any traffic. This situation, known as idle listening, is often true as most applications that do not occupy the medium full-time, such as web browsing and email. Even for streaming video, which uses a 8 Mbps rate, the WLAN medium is idle for more than 60% of the time when the WLAN data rate of 54 Mbps is used. This means that a conventional AP wastes energy for more than 60% of the time while waiting for incoming data. SAP 402 cannot turn off its radio even when there is no current traffic due to the unpredictable timing of packet arrival.

FIG. 5 illustrates the benefits of one solution to the above-noted problems in accordance with one embodiment of the invention. A micro rate control algorithm is used to delay transmissions from STA 501 and to allow SAP 502 to go to sleep (i.e. power down its transceiver and/or processor) for a short period of time during this delay.

In this example, the SAP 502 generates a Defer Control (“DeferCtl”) frame 500, such as CTS2Self (clear to send to self) frame, a frame with large TXOP (transmission opportunity), or some other frame that could delay transmissions from STA 501. Because SAP 502 knows that no packets will arrive during this period of time, the SAP 502 can safely turn off its radio in order to save energy. By using this DeferCtl frame, the algorithm achieves two goals at the same time. First, when the packet arrival rate is higher than what the SAP 502 can handle (as shown by WLAN packets in FIG. 3), the DeferCtl frames reduce the rate of packet arrivals. This rate control allows SAP 502 to go to sleep during intervals 503 to save energy, avoids buffer overflow, allows smaller buffer size at SAP 502, reduces workload of the host system of SAP 502, and helps STA's 501 to recognize congested network sooner. Second, when the packet arrival rate is lower than what the PHY rate can handle (as shown in the peer-to-peer data exchange scenario in FIG. 4), the algorithm regulates the way of packet arrivals. When the SAP 502 turns on its radio, there are often multiple waiting packets queued up at STA 502, allowing the channel to be fully utilized during the awake mode. At the same time, SAP 502 can go to sleep from time to time to save more energy.

In other embodiments, a specific type of control frame (referred to here as a Notification of Absence frame, or NOA) may be used by SAP device 502 to notify the STA device 501 that the SAP device will be unavailable for receiving during a specified period of time. The NOA control frame indicates a time at which the period of absence starts and may also indicate periodicity of such absence periods. As periodicity can be specified, a NOA control frame can replace multiple DeferCtl frames illustrated in FIG. 5.

The same strategy can also be applied to downlink traffic. Instead of transmitting all downlink traffic immediately, SAP 502 transmits DeferCtl to defer its own transmission and go to sleep if average traffic load is far below the throughput that can be supported by PHY rate. After this deferring, hopefully multiple packets have been accumulated at the SAP 502 and thus the SAP 502 can transmit them back-to-back, fully utilizing the channel capacity. SAP 502 preferably defers its transmission corresponding to Quality of Service (QoS) requirements of the packets. For example, a VoIP packet should not be deferred or should only be deferred for several milliseconds in order to maintain the desired QoS.

The micro rate control algorithm looks at several parameters to decide when to send a DeferCtl frame and how long the DeferCtl frame should defer transmissions from STA 501. Two of the most important parameters are (1) the number of packets to be bridged to a different network and (2) medium idle time. Remaining buffer size of the host 502 often can be a good estimation of the number of pending packets to be bridged by the host 502. On the other hand, average throughput and PHY rate can be used to estimate medium idle time. The SAP 502 can adjust the frequency of DeferCtl frames and the delay duration in each of them.

The micro rate control scheme disclosed herein has the following advantages:

Compliance with IEEE 802.11 standards—the micro rate control frame can use CTS2Self or a frame with large TXOP, which are already part of the IEEE 802.11 standards. The Notice of Absence (NOA) and Opportunistic Power-Save frames in the Wi-Fi Direct Standard, which is currently under development, may also be used to control transmission time of the stations, such as STA 501, so that SAP device 502 can sleep between transmissions and minimize energy use.

Efficiency and energy saving—the rate-control algorithm allows SAP 502 to go to sleep during the delay specified in the DeferCtl frames. The SAP device may use guard periods before and/or after it enters a sleep mode. For example, if the data rate is low and SAP 502 generates a DeferCtl with a delay of eight milliseconds periodically. The SAP 502 may start turning on the radio at the seventh milliseconds of this delay so that the radio is ready to receive packet at the end of this eight millisecond delay or to receive packets that are sent too soon by the client—i.e. packets sent before the end of the delay due to timing or clock differences. After that, the SAP 502 stays awake for one millisecond longer to detect any additional incoming packets and then sends a DeferCtl frame again if no packet arrives. In this case, the SAP 502 can put its radio in sleep for more than 75% of the time in some embodiments.

Ignorable penalty to throughput and latency—because the algorithm limits only the rate at a micro level (e.g. less than ten milliseconds) each time, extra latency introduced by the algorithm is ignorable compared to large latency experienced by a packet to a host in the Internet. The SAP 502 turns off its radio only when the PHY is underutilized and, therefore, does not limit throughput. For example, in the scenario of bridging to a cellular network, the algorithm begins to limit rate when there are many packets sitting in the queue of the SAP 502. The algorithm delays only the time that a packet from the STA 501 is added to the queue, so the overall time that the packet is sent to the cellular network is not necessarily delayed.

The process improves packet delivery ratio and reduced buffer size for bridging between cellular and WLAN networks. Rate control helps the SAP 502 to avoid accepting more packets when it is overloaded, thereby avoiding buffer overflow and allowing the use of a smaller buffer size in system design.

Embodiments of the present invention use the DeferCtl, TXOP, CTS2Self, Notice of Absence, or Opportunistic Power-Save frame or commands to optimize the end-to-end throughput of a network while minimizing the power usage of the SAP device that is receiving packets or bridging two different networks. The SAP device determines (1) when to enter a sleep mode during which the radio transceiver is turned off, and (2) how long to remain in the sleep mode and still balance the end-to-end throughput achievable by the SAP device. Embodiments of the invention identify throughput bottlenecks and then spend enough energy to support the throughput achievable at the bottleneck. The throughput bottleneck may be, for example, a lower data rate network, such as the cellular network in the example of FIG. 3, which is much slower than the WLAN network. Known systems expend excess energy supporting the higher speed network using, for example, data buffers to store data received on the high speed network that cannot immediately be transmitted on the slower network. Embodiments of the present invention effectively slow the transmission of data on the higher-speed network to a rate that can be supported by the slower network. This allows the SAP device to operate only as needed to support the achievable throughput data rate and to turn off components that consume high power levels, such as transmitters, receivers, processors and buffers, when they are not needed.

Referring again to FIG. 3, the PHY rate achievable over the cellular network is 2 Mbps while the PHY rate achievable over the WLAN network is 54 Mbps. Clearly, the SAP device 301 cannot fully utilize the WLAN PHY rate for data that is exchanged between devices 302 and 303. Accordingly, SAP device 301 turns off its transmitter and receiver to save power and turns on the transmitter and receiver only long enough to support the PHY rate of the cellular network. Also, by limiting the rate that data is received, SAP device 301 does not receive more data from the WLAN network than it can send over the cellular network and, therefore, there is no need to store or buffer the data waiting to be transmitted over the cellular network.

The SAP device may designate transmission windows for STA device in any appropriate manner. For example, the SAP device may designate a period of absence during which it will be in a sleep mode, off-line or otherwise unavailable to receive data packets. The STA device buffers data packets during this period of absence and begins transmitting the buffered data at the end of the period of absence. The period of absence may be a single event or the SAP device may notify the STA client of two or more recurring periods of absence. The recurring periods of absence may be of a fixed or variable duration. The message or frame designating the period of absence may identify the start of the period of absence as occurring immediately or at a fixed future time. The message or frame may further define the period of absence as having a specific duration or may define a specific end time for the period of absence.

Alternatively, instead of defining a period of absence or unavailability, the SAP device may define one or more periods or windows during which it will be available to receive transmissions from the STA client. The message or frame designating the period or window during which the SAP device will receive data may also define a duration for the receive window. The start time of the receive window may be a single or reoccurring fixed or variable time. Similarly, the duration of the receive window may be of fixed or variable duration.

Referring to FIG. 5, SAP enabled device 502 may define a period of absence 503 having a particular start time 504 and end time 505 and/or duration 506. Subsequent periods of absence 507 may be defined having the same or different durations. Subsequent periods 507 may start at regular intervals or at variable times. Alternatively, SAP enabled device 502 may define a transmission window 508 during which its receiver will be powered on and ready to receive data packets. Transmission window 508 may be defined as having a start time 505 and end time 509 and/or duration 510. Subsequent transmission windows 511 may also be defined. Subsequent transmission windows 511 may have the same, different or variable durations compared to window 508 and may occur at fixed or variable intervals.

Although a period of absence or transmission window is defined by SAP-enabled device 502, it may actually power-up and operate its receiver, transmitter, processor, buffers and/or other components earlier than period of absence end time/transmission window start time 505 to provide a guard time in situations where the clock or timing of STA client device is not adequately synchronized. Similarly, SAP-enabled device 502 may actually power-down its receiver, transmitter, processor, buffers and/or other components and enter a sleep-mode later than period of absence start time/transmission window end time 509 to provide a guard time.

Embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine, such as a computer. For example, a machine-readable medium may include a tangible storage medium, such as but not limited to read only memory (ROM), random access memory (RAM), magnetic disk storage media, optical storage media, flash memory devices and the like.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. An access point, comprising:
a wireless receiver for receiving data from a first network;
a wireless transmitter for transmitting data to one or more devices on the first network;
a processor coupled to the receiver and the transmitter, the processor adapted to process data packets received from the first network and to generate messages to be transmitted to the one or more devices, the processor operating to:
identifying a minimum throughput rate;
determining a receive window duration required to support the minimum throughput rate;
sending transmit instructions to the one or more devices on the first network, the transmit instructions identifying a period of absence;
placing the receiver in a sleep mode during at least a portion of the period of absence, the sleep mode preventing the receiver from receiving data from the first network; and
placing the receiver in an active mode at times outside the period of absence.

2. The access point of claim 1, further comprising:
a memory coupled to the processor, the memory storing access point functionality software.

3. The access point of claim 1, wherein the transmit instructions further identify a start time and a duration for the period of absence.

4. The access point of claim 3, wherein the transmit instructions further identify an interval separating a plurality of periods of absence.

5. The access point of claim 1, further comprising:
an interface for transmitting data to a second network, and the processor operating to:
identify a first throughput rate for the first network;
identify a second throughput rate for the second network;
determine a lowest throughput rate between the first throughput rate and the second throughput rate, and wherein the lowest throughput rate is the minimum throughput rate.

6. The access point of claim 5, wherein the interface is a wireless transmitter adapted to transmit data to the second network.

7. The access point of claim 1, further comprising:
a battery providing power to the receiver, interface, and processor.

8. A method, comprising:
identifying a first throughput rate for a first network;
determining a minimum transmit duration to support the first throughput rate;
instructing a device on the first network to transmit only during repetitive transmission windows, a duration of the repetitive transmission windows selected based on the minimum transmit duration;
placing a receiver in a sleep mode;
placing the receiver in an active mode during the repetitive transmission windows; and
returning the receiver to the sleep mode following the end of the repetitive transmission windows.

9. The method of claim 8, wherein a clear to send to self (CTS2Self) frame is used to instruct the device regarding the transmission window.

10. The method of claim 8, wherein a transmission opportunity (TXOP) frame is used to instruct the device regarding the transmission window.

11. The method of claim 8, wherein a notice of absence (NoA) or an opportunistic power-save message is used to instruct the device regarding the transmission window.

12. The method of claim 8, wherein the repetitive transmission windows begin at fixed intervals.

13. The method of claim 8, wherein the repetitive transmission windows begin at variable intervals.

14. The method of claim 8, wherein the durations of the repetitive transmission windows are variable.

15. The method of claim 8, wherein the placing the receiver in an active mode occurs prior to a start time of a repetitive transmission window.

16. The method of claim 8, wherein the placing the receiver in an active mode occurs after an end time of a repetitive transmission window.

17. A method, comprising:
identifying a first throughput rate for a first network;
identifying a second throughput rate for a second network;
comparing the first throughput rate to the second throughput rate to determine a minimum throughput rate;
determining a repetitive transmission window size required to support the minimum throughput rate;
instructing a device to transmit only during transmission windows, the transmission windows occurring at intervals;
placing a receiver in a sleep mode during periods outside the transmission windows;
placing the receiver in an active mode during the transmission windows; and
returning the receiver to the sleep mode at the end of the transmission windows.

18. The method of claim 17, wherein the first network is a Wi-Fi network operating according to a IEEE 802.11 protocol, and the second network is a cellular telephone network, and
wherein the device is located on the Wi-Fi network.

19. The method of claim 17, further comprising:
receiving one or more data packets from the device over the first network during the transmission windows; and
forwarding the data packets to the second network.

20. The method of claim 17, wherein the transmission windows begin at variable intervals.

21. The method of claim 17, wherein the durations of the transmission windows are variable.
